(19) United States
(12) Patent Application Publication
(10) Pub. No.: US 2014/0319117 A1
(43) Pub. Date: Oct. 30, 2014

(54) HARNESS FOR ELECTRIC HEATING CATALYST

(71) Applicant: Sumitomo Wiring Systems, Ltd., Yokkaichi-City (JP)

(72) Inventor: Takeru Miyamoto, Yokkaichi-City (JP)

(73) Assignee: Sumitomo Wiring Systems, Ltd., Yokkaichi-City (JP)

(21) Appl. No.: 14/265,712

(22) Filed: Apr. 30, 2014

(30) Foreign Application Priority Data
Apr. 30, 2013 (JP) 2013-095132

(51) Int. Cl. F01N 3/00; B01D 53/94

(52) U.S. Cl. CPC F01N 3/00; B01D 53/94
USPC 219/205; 422/174

(57) ABSTRACT

A harness for electric heating catalyst (20) is connected to a catalyst case (12) housing a catalyst for purifying exhaust gas of an internal combustion engine and provided in an exhaust gas pipe (11) for exhausting the exhaust gas and includes a wire (50) connected to a power supply, and an electrode main body (70) for relay-connecting a case-side terminal (13) provided in the catalyst case (12) and the wire (50) and radiating heat transferred to the case-side terminal (13) from the heated catalyst. According to such a configuration, since the wire (50) is connected to the case-side terminal (13) of the catalyst case (12) via the electrode main body (70), heat transferred from the heated catalyst to the case-side terminal (13) is released into air at the electrode main body (70). Thus, damage to the wire (50) can be prevented by efficiently radiating the heat from the catalyst.

### BACKGROUND

1. Field of the Invention

The invention relates to a harness for electric heating catalyst and an electric heating catalyst device.

2. Description of the Related Art

A catalyst that is used for exhaust gas purification does not function sufficiently when the catalyst is cold such as when an engine of an automotive vehicle is started. Japanese Unexamined Patent Publication No. H05-79321 discloses an arrangement for electrically warming the case that houses the catalyst to suppress the early release of toxic substances. However, electric heating is not necessary once the exhaust gas becomes sufficiently hot to maintain the temperature of the catalyst.

A wire for the electric heating of the catalyst is connected directly to a case-side terminal in the catalyst case. This wire is heated and easily can be damaged. A metal plate is provided to cool the case-side terminal. However, heat is transferred more quickly to the wire than to the metal plate and into the air because the wire is connected directly to the case-side terminal. Thus, a heat radiation effect by the metal plate is very low.

The invention was completed based on the above situation and aims to prevent damage to the wire.

### SUMMARY OF THE INVENTION

The invention relates to a harness to be connected to a catalyst case that houses a catalyst for purifying exhaust gas of an internal combustion engine. The catalyst is provided at least partly in a pipe for exhausting the exhaust gas. The harness includes a wire to be connected to a power supply and a heat radiating portion for relay-connecting the wire to a terminal in or at the catalyst case. The heat radiating portion is able to radiate heat transferred from the heated catalyst to the terminal.

The wire is connected to the terminal of the catalyst case via the heat radiating portion instead of being connected directly to the terminal of the catalyst case. Heat transferred from the heated catalyst to the terminal can be radiated from the heat radiating portion. Thus, damage of the wire can be prevented by efficiently radiating the heat from the catalyst.

The heat radiating portion may be substantially in the form of a bar with opposite first and second ends. The terminal may be connected to first end of the heat radiating portion. Thus, the heat radiating portion has a large surface area and a long heat transfer distance from the terminal to the wire can be obtained since the terminal is connected to the first end of the heat radiating portion.

The wire may be connected to the second end of the heat radiating portion, and hence the end opposite the terminal. Thus, the heat radiating portion has a large surface area and a long heat transfer distance from the terminal to the wire.

A core may be exposed at an end of the wire. The core preferably is made of a plated wire (such as nickel plated copper wire), and the heat radiating portion may be made of stainless steel. A plated wire core is not easily press-fit directly to the second end of the heat radiating portion. Accordingly, a connecting component may be provided. The connecting component may be crimped into connection with the core and press-fit to the second end of the heat radiating portion.

The wire may be accommodated at least partly in a pipe made of metal or another material having a high thermal capacity. Accordingly, radiant heat radiated from the catalyst case and the pipe for the exhaust gas can be blocked by the pipe and the wire will not be damaged by radiant heat.

A pipe holder may be connected to an end part of the pipe may, and the heat radiating portion may be accommodated partly in the pipe holder. Thus, the pipe holder protects the heat radiating portion can be partly protected by the pipe holder.

The first end of the heat radiating portion may project from a first opening of the pipe holder or pipe and a seal may be interposed between the heat radiating portion and the opening of the pipe holder or pipe. The seal prevents exhaust gas from entering into the pipe holder.

The wire may be exposed to the outside from a second opening of the pipe and a cap may be attached to the second opening. The cap may act as a seal that allows only the wire to be inserted in a sealed state while substantially closing the second opening of the pipe.

The heat radiating portion may be made of stainless steel.

The harness for electric heating catalyst may further comprise a seal formed with a shaft hole for allowing insertion of a shaft of the heat radiating portion.

An end of the seal opposite to the connecting component may be held in contact with the heat radiating portion. A gasket may be mounted on an end of the seal opposite to the connecting component and may be fixed by a screw mounted on the shaft.

The seal may be made of ceramic. The gasket may be made of mica. The screw may be made of stainless steel

The invention also relates to an electric heating catalyst device comprising a catalyst case housing a catalyst for purifying exhaust gas of an internal combustion engine and at least partly provided in a pipe for exhausting the exhaust gas. The device further comprises at least one harness as described above.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a plan view showing an electric heating catalyst device.

FIG. 2 is an exploded perspective view showing constituent components of a harness for electric heating catalyst.

FIG. 3 is a plan view of the harness for electric heating catalyst.

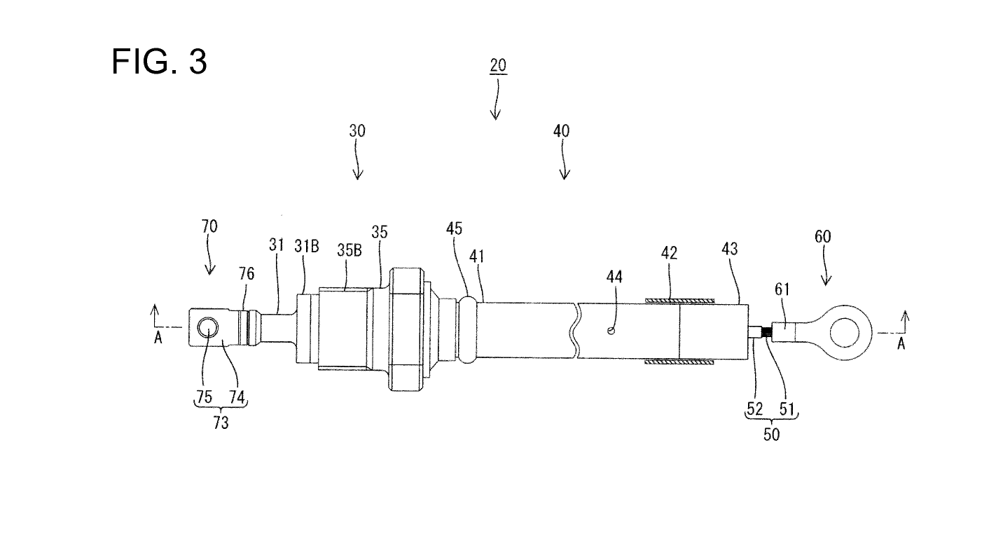

FIG. 4 is a section along A-A of FIG. 3.

FIG. 5 is a front view of the harness for electric heating catalyst.

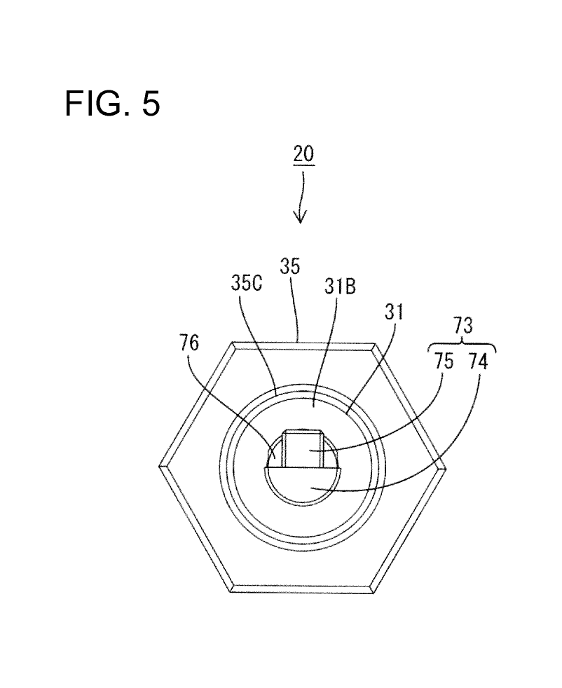

### DETAILED DESCRIPTION OF THE PREFERRED EMBODIMENTS

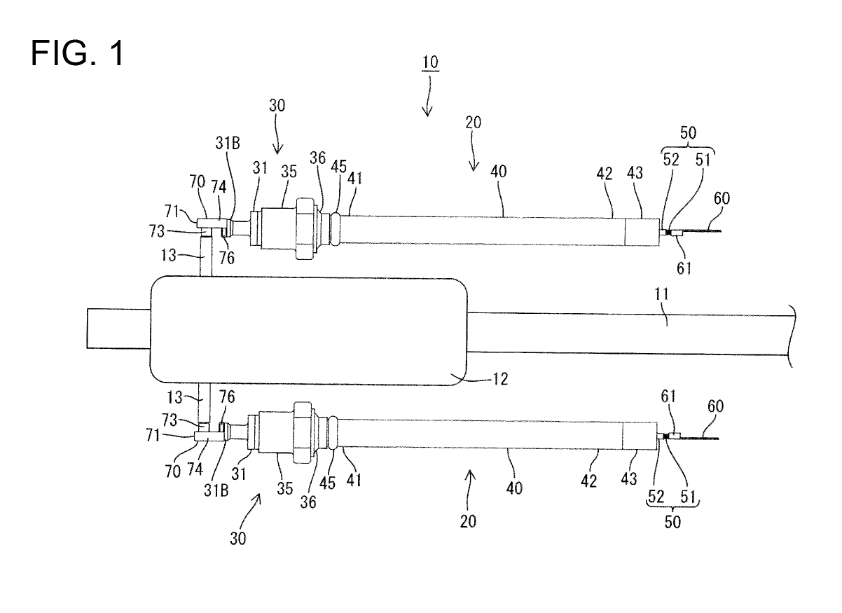

An electric heating catalyst device is identified by the numeral 10 in FIG. 1 and includes a harness 20 for providing electricity to and/or communication signals to and from the electric heating catalyst device 10 from an unillustrated power supply and/or a control device for hybrid vehicle. The electric heating catalyst device 10 includes a catalyst case 12 at an intermediate position of an exhaust gas pipe 11 for exhausting exhaust gas to the outside of a vehicle, two case-side terminals 13 that project from an outer surface of the catalyst case 12, and two electric heating catalyst (hereinafter EHC) harnesses 20 respectively connected to the case-side terminals 13. The EHC harnesses 20 are juxtaposed at substantially opposite sides of the exhaust gas pipe 11. The EHC harnesses 20 are in a high-temperature environment caused by radiant heat radiated from the exhaust gas pipe 11 and in a highly contaminated environment caused by the exhaust gas.

A catalyst for purifying the exhaust gas generated in an internal combustion engine is housed in the catalyst case 12. The catalyst can function well when heated to or above a specified temperature. Exhaust gas from an engine is hot and keeps the catalyst of a gasoline engine vehicle constantly in a warmed state. On the other hand, an engine is not necessarily always operating in a hybrid vehicle or a vehicle having a so-called sailing mode in which the combustion engine is switched off temporarily e.g. in a substantially steady motion of the vehicle. The engine may be restarted if a catalyst falls below a specified temperature so that the exhaust gas heats the catalyst. However, this approach reduces fuel economy. Fuel economy can be improved by electrically heating the catalyst without restarting the engine.

As shown in FIG. 1, the EHC harness 20 includes an electrode unit 30 to be connected to the case-side terminal 13. An aluminum pipe 40 is arranged along the catalyst case 12 and the exhaust gas pipe 11 from the electrode unit 30. At least one wire 50 is arranged in the pipe 40 and a substantially round terminal 60 is crimped into connection to an end part of the wire 50. The terminal 60 is to be connected electrically to an unillustrated battery installed in the vehicle via unillustrated wiring harness and inverter and the like. The pipe 40 has a first opening 41 and a second opening 42.

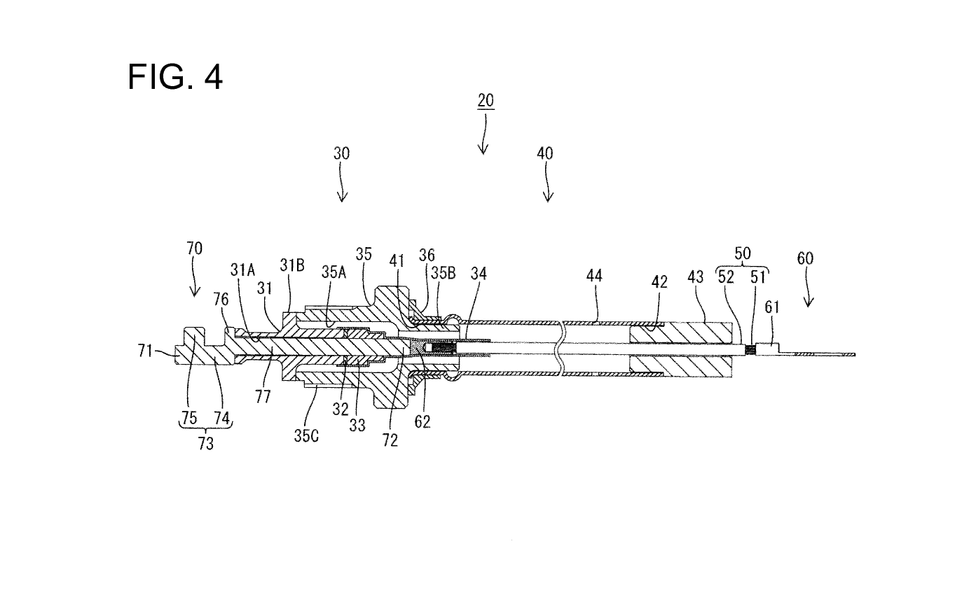

The wire 50 connected to the round terminal 60 is exposed outside of the second opening 42 of the pipe 40 and an aluminum cap 43 is attached to the second opening 42. The aluminum cap 43 is a seal that allows only the wire 50 to be inserted in a sealed state while substantially closing the second opening 42 of the pipe 40. As shown in FIG. 4, the aluminum cap 43 is press-fit into the second opening 42. Further, two vent holes 44 penetrate through the pipe 40 near the aluminum cap 43.

The wire 50 is a heat resistant coated wire with core 51 made of a plated wire (particularly a nickel plated copper wire) and a coating 52 (particularly made of fluororesin) covers the core 51. The coating 52 is removed at an end of the wire 50 to expose the core 51 and a barrel 61 of the terminal 60 is crimped, bent of folded into connection with the core 51. It should be noted that other electrical connections (e.g. including welding) may be adopted to electrically connect the wire 50 to the terminal 60.

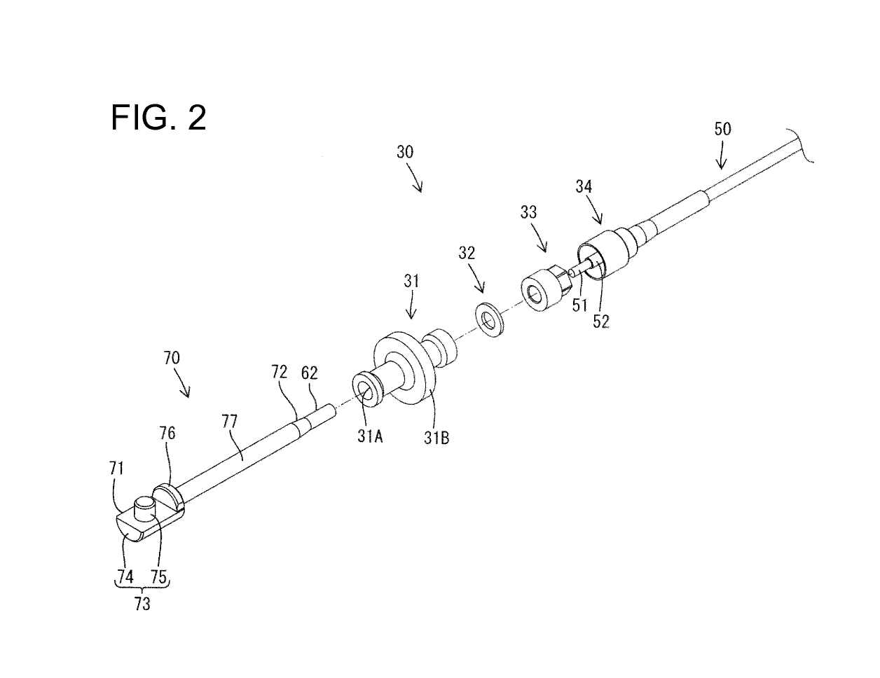

As shown in FIG. 2, the electrode unit 30 includes an electrode main body 70 made of stainless steel, a seal 31 made of ceramic, a gasket 32 made of mica, and/or a screw 33 made of stainless steel and the like. The electrode main body 70 has opposite first and second ends 71 and 72. As shown in FIG. 4, a wire terminal 62 is crimped and connected to an end of the wire 50 opposite to the round terminal 60 and the wire terminal 62 is press-fit frictionally to the second end 72 of the electrode main body 70.

As shown in FIG. 2, the electrode main body 70 is substantially in the form of a bar, and the wire terminal 62 is connected to the second end 72, whereas an electrode terminal 73 is formed unitarily to the first end 71. The electrode terminal 73 includes a pedestal 74 formed by dividing a cylinder in half and a substantially cylindrical connecting portion 75 standing substantially perpendicular or upright from a dividing surface of the pedestal 74. The tip of the connecting portion 75 is to be connected to the tip of the case-side terminal 13 as shown in FIG. 1. Further, a substantially circular seal receiving portion 76 is formed laterally to the pedestal 74, and a shaft 77 substantially in the form of a round bar projects from the seal receiving portion 76. The wire terminal 62 is to be frictionally press-fit to the tip of this shaft 77 for connection.

As shown in FIG. 2, the seal 31 is formed with a shaft hole 31A for allowing the insertion of the shaft 77 of the electrode main body 70, and a flange 31B is formed near an axial center of the seal 31. The end of the seal 31 opposite the wire terminal 62 is to be held in contact with the seal receiving portion 76 of the electrode main body 70. On the other hand, the gasket 32 is to be mounted on the end of the seal 31 opposite to the wire terminal 62 and is fixed by the screw 33 mounted on the outer periphery of the shaft 77.

An insulating or separating layer in the form of a heat shrinkable tube 34 is mounted from the end of the seal 31 to the coating 52 of the wire 50 via the gasket 32, the screw 33 and the wire terminal 62 to avoid contact of another conductive member with the shaft 77 of the electrode main body 70 between the screw 33 and the wire terminal 62.

A pipe holder 35 is to be mounted on the first opening 41 and an insertion hole 35A is formed in the pipe holder 35 for receiving the electrode main body 70 and the wire 50. As shown in FIG. 4, the flange 31B of the seal 31 is to be substantially in contact with an opening edge of the insertion hole 35A of the pipe holder 35 to prevent exhaust gas from entering into the pipe 40 through the insertion hole 35A of the pipe holder 35.

The pipe holder 35 is formed with a mounting tube 35B to be fit into the first opening 41 of the pipe 40. The pipe 40 is fit externally on the outer periphery of the mounting tube 35B and a holding tube 36 is mounted on the outer periphery of the pipe 40 to hold the pipe 40 on the pipe holder 35. Further, an annular step or enlarged portion 45 bulges out at a position of the outer periphery of the pipe 40 substantially adjacent to the holding tube 36.

A screw groove 35C is formed on a side of the outer periphery of the pipe holder 35 opposite to the mounting tube 35B. On the other hand, the case-side terminal 13 is to be mounted in an unillustrated terminal block, and the pipe holder 35 is to be fixed to the terminal block by threadedly engaging the screw groove 35C of the pipe holder 35 with this terminal block.

The EHC harness 20 is assembled by first removing the coating 52 at opposite ends of the wire 50 to expose the core 51. The seal 31, the gasket 32 and the screw 33 are mounted on the shaft 77 of the electrode main body 70, and the gasket 32 is fixed to the end of the seal 31 by the screw 33. Thereafter, the core 51 on one end is connected to the wire terminal 62 and the wire terminal 62 is connected to the first end 71 of the electrode main body 70. Subsequently, the heat shrinkable tube 34 mounted on the wire in advance is mounted on the coating 52 of the wire 50 from the end part of the seal 31, and is caused to shrink by being heated.

Subsequently, the mounting tube 35B of the pipe holder 35 is inserted into the one opening 41 of the pipe 40 and the pipe 40 is fixed to the mounting tube portion 35B of the pipe holder 35 by mounting the holding tube 36. The core 51 of the wire 50 then is inserted into the insertion hole 35A of the pipe holder 35 and caused to project from the second opening 42 of the pipe 40. Further, the wire 50 projecting from the second opening 42 of the pipe 40 is inserted through the aluminum cap 43 and the aluminum cap 43 is press-fit into the second opening 42. Subsequently, the core 51 of the wire 50 projecting from the aluminum cap 43 is connected to the wire 50 by being placed in the barrel 61 of the terminal 60 and a crimping operation is performed. The barrel 61 of the terminal 60 then is connected to the core 51 to complete the assembly of the EHC harness 20.

The screw groove 35C of the pipe holder 35 of the EHC harness 20 is threadedly engaged with the unillustrated terminal block. Thereafter, the electrode terminal 73 and the case-side terminal 13 are connected electrically conductively. The electric heating catalyst device 10 is formed by respectively connecting the two harnesses for electric heating catalyst 20 to the two case-side terminals 13. The catalyst is heated electrically when this electric heating catalyst device 10 is energized. When the catalyst reaches the specified temperature or higher, a state is reached where the exhaust gas can be purified. When the catalyst reaches a high-temperature state, the case-side terminals 13 also reaches a high-temperature state and heat is transferred to the electrode main body 70. However, this heat is cooled while being transferred from the electrode terminal 73 to the wire terminal 62 through the shaft 77. Thus, the wire 50 does not reach a high-temperature. Further, the exhaust gas pipe 11 reaches a high-temperature due to the exhaust gas and the pipe 40 is heated by radiant heat from the exhaust gas pipe 11. However, the radiant heat is reflected by the surface of the pipe 40. Therefore the wire 50 is not heated. Further, the wire 50 is covered by the pipe holder 35 and the pipe 40, it is not damaged due to an external impact.

As described above, the wire 50 is connected to the case-side terminal 13 of the catalyst case 12 via the electrode main body 70 instead of being directly connected to the case-side terminal 13 of the catalyst case 12. Thus, heat transferred from the heated catalyst to the case-side terminal 13 is released into air at the electrode main body 70. Therefore, damage of the wire 50 can be prevented by efficiently radiating the heat from the catalyst.

The electrode main body 70 is substantially in the form of a bar and the case-side terminal 13 is connected to the one end part 71 of the electrode main body 70. Accordingly, a large surface area of the electrode main body 70 can be obtained since the electrode main body 70 is substantially in the form of a bar, and a long heat transfer distance from the case-side terminal 13 to the wire 50 can be obtained since the case-side terminal 13 is connected to the first end 71 of the electrode main body 70.

The electrode main body 70 is substantially in the form of a bar and the wire 50 is connected to the second end 72 of the electrode main body 70. According to such a configuration, a large surface area of the electrode main body 70 can be obtained since the electrode main body 70 is substantially in the form of a bar, and a long heat transfer distance from the case-side terminal 13 to the wire 50 can be obtained since the wire 50 is connected to the first end 71 of the electrode main body 70.

The core 51 is exposed substantially at the end of the wire 50, the wire terminal 62 is connected to the core 51 and the wire terminal 62 is press-fit to the second end part 72 of the electrode main body 70. For example, if the electrode main body 70 is made of stainless steel and the core 51 is made of a plated conductive material (such as a nickel plated copper wire), it is difficult to directly press-fit the core 51 to the second end part 72 of the electrode main body 70. Accordingly, by interposing the wire terminal 62 between the second end part 72 of the electrode main body 70 and the core 51, the wire terminal 62 can be connected to the electrode main body 70 by being press-fit and can be connected to the wire 50 by being crimped.

The wire 50 is accommodated in the pipe 40 e.g. made of metal or a material having a high heat capacity. Accordingly, radiant heat radiated from the catalyst case 12 and the exhaust gas pipe 11 for the exhaust gas can be blocked and the damage of the wire 50 due to radiant heat can be prevented.

The pipe holder 35 to be connected to the end of the pipe 40 is provided and the electrode main body 70 is accommodated in this pipe holder 35. Accordingly, the electrode main body 70 is protected by the pipe holder 35.

The first end 71 of the electrode main body 70 projects from first opening of the pipe holder 35 and the seal 31 particularly is interposed between the electrode main body 70 and the first opening of the pipe holder 35. Accordingly, the seal 31 prevents entrance of exhaust gas into the pipe holder 35.

The invention is not limited to the above described embodiment. For example, the following embodiments also are included in the scope of the invention.

The electrode main body 70 is in the form of a bar in the above embodiment. However, it need not be a bar and may include at least one cooling fin.

Although the case-side terminal 13 and the wire terminal 62 are connected to the substantially opposite end parts 71, 72 of the electrode main body 70 in the above embodiment, each terminal may be connected at an intermediate position other than at the opposite end parts of the electrode main body according to the present invention.

The electrode main body 70 is connected to the wire 50 via the wire terminal 62 in the above embodiment. However, it may be directly connected to the wire 50. Even if the electrode main body 70 is connected via the wire terminal, a connection method does not matter.

The wire 50 is accommodated in the pipe 40 in the above embodiment, but heat from the exhaust gas pipe 11 may be blocked in a different way according to the invention. In such a case, the wire need not be necessarily covered by the pipe.

Although the pipe 40 is held by the pipe holder 35 in the above embodiment, it may be held directly on the terminal block without the pipe holder being interposed.

Sealing is provided between the electrode main body 70 and the opening edge part of the pipe holder 35 by the seal 31 in the above embodiment. However, sealing may be provided using a gasket instead of the seal according to the present invention.

The electrode main body 70 made of stainless steel is used in the above embodiment. Kinds of stainless steel as a base material of this electrode main body include, for example, SUS 430. Further, the seal 31 made of ceramic is used in the above embodiment. Kinds of ceramic as a base material of this seal member include, for example, alumina. However, the kinds of stainless steel and ceramic are not limited to these materials.

What is claimed is:

1. A harness for electric heating catalyst (20) to be connected to a catalyst case (12) housing a catalyst for purifying exhaust gas of an internal combustion engine and at least partly provided in a pipe (11) for exhausting the exhaust gas, comprising:
a wire (50) to be connected to a power supply; and
a heat radiating portion (70) for relay-connecting a terminal (13) to be provided at the catalyst case (12) and the wire (50) and being configured for radiating heat transferred to the terminal (13) from the heated catalyst.

2. The harness for electric heating catalyst of claim 1, wherein the heat radiating portion (70) is a bar and the terminal (13) is connected to a first end (71) of the heat radiating portion (70).

3. A harness for electric heating catalyst of claim 1, wherein the heat radiating portion (70) is a bar and the wire (50) is connected to a second end (72) of the heat radiating portion (70).

4. A harness for electric heating catalyst of claim 3, wherein a core (51) is exposed at an end of the wire (50), and a connecting component (62) is connected to the core (51) and press-fit to the second end (72) of the heat radiating portion (70).

5. A harness for electric heating catalyst of claim 2, wherein the wire (50) is accommodated at least partly in a metal pipe (40).

6. A harness for electric heating catalyst of claim 5, further comprising a pipe holder (35) connected to an end of the pipe (40), wherein the heat radiating portion (70) is partly accommodated in the pipe holder (35).

7. A harness for electric heating catalyst of claim 6, wherein the first end (71) of the heat radiating portion (70) projects from a first opening (41) of the pipe holder (35) or the pipe (40) and a seal (31) is interposed between the heat radiating portion (70) and the first opening (41).

8. The harness for electric heating catalyst of claim 5, wherein the wire (50) is exposed to outside from a second opening (42) of the pipe (40) and a cap (43) is to be attached to the second opening (42).

9. The harness for electric heating catalyst of claim 8, wherein the cap (43) seals the second opening (42) and allows only the wire (50) to be inserted in a sealed state while substantially closing the second opening (42) of the pipe (40).

10. The harness for electric heating catalyst of claim 1, wherein the heat radiating portion (70) is made of stainless steel.

11. The harness for electric heating catalyst of claim 1, further comprising a seal (31) formed with a shaft hole (31A) for allowing the at least partial insertion of a shaft portion (77) of the heat radiating portion (70).

12. The harness for electric heating catalyst of claim 11, wherein the seal (31) has opposite first and second ends, the first end of the seal (31) being opposite to the connecting component (62) and being held in contact with the heat radiating portion (70), and a gasket (32) being mounted on an end of the seal (31) opposite the connecting component (62) and being fixed by a screw (33) mounted on the shaft (77).

13. The harness for electric heating catalyst of claim 11, wherein the seal (30) is made of ceramic and/or wherein the gasket (32) is made of mica.

14. An electric heating catalyst device (10) comprising a catalyst case (12) housing a catalyst for purifying exhaust gas of an internal combustion engine and to be at least partly provided in a pipe (11) for exhausting the exhaust gas, further comprising the harness for electric heating catalyst (20) of claim 1.
